(19) United States
(12) Patent Application Publication
(10) Pub. No.: US 2012/0021255 A1
(43) Pub. Date: Jan. 26, 2012

(54) BATTERY PACK AND METHOD FOR CONTROLLING OF CHARGING AND DISCHARGING OF THE SAME

(75) Inventor: Young-Bok KIM, Yongin-si (KR)

(73) Assignee: SAMSUNG SDI CO., LTD., Yongin-si (KR)

(21) Appl. No.: 13/184,166

(22) Filed: Jul. 15, 2011

(30) Foreign Application Priority Data
Jul. 23, 2010 (KR) 10-2010-0071644

(51) Int. Cl. H01M 10/44; H02J 7/04

(52) U.S. Cl. 429/7; 320/134

(57) ABSTRACT

A battery pack capable of safely control charging and discharging and a method of controlling this charging and discharging. The battery pack includes a battery assembly at least one battery cell, a protective circuit board electrically connected to the battery assembly, and an outer terminal electrically connecting the battery assembly to an external power supply or an external load. The protective circuit board includes a charging and discharging device charging and discharging the battery assembly, a temperature device measuring the temperature of the battery assembly; and a charging and discharging controller electrically connected to the battery assembly, the charging and discharging device, and the temperature device and controlling the charging and discharging of the battery assembly. The temperature device is set to measure the temperature of the battery assembly in the state in which the charging and discharging of the battery assembly stops.

### CLAIM OF PRIORITY

This application makes reference to, incorporates the same herein, and claims all benefits accruing under 35 U.S.C. §119 from an application earlier filed in the Korean Intellectual Property Office on Jul. 23, 2010 and there duly assigned Serial No. 10-2010-0071644.

### BACKGROUND OF THE INVENTION

1. Field of the Invention

The described technology relates generally to a battery pack.

2. Description of the Related Art

Unlike a primary battery, a rechargeable battery is a battery capable of performing charging and discharging and can repeat a charging process of converting external electrical energy into chemical energy and storing it and a discharging process of converting chemical energy into electrical energy and using it.

An example of a representative rechargeable battery may include a nickel hydrogen battery, a nickel cadmium battery, a lithium ion battery, a lithium polymer battery, or the like. A low-capacity rechargeable battery has been prevalently used for a portable small electronic device such as a mobile phone, a laptop computer, and a camcorder and a large-capacity rechargeable battery is used for a power supply for driving a motor such as a hybrid vehicle, or the like and a battery for storing power.

In the fields closely connected with real life, as the use of the rechargeable battery is increased, the rechargeable battery with high safety and reliability is needed.

The above information disclosed in this Related Art section is only for enhancement of understanding of the background of the described technology and therefore it may contain information that does not form the prior art that is already known in this country to a person of ordinary skill in the art.

### SUMMARY OF THE INVENTION

Aspects of the described technology has been made in an effort to provide a battery pack having advantage of safely resuming charging and discharging when the charging and the discharging of the battery pack stop due to overvoltage or overcurrent.

Further, aspects of the described technology has been made in an effort to provide a method for controlling charging and discharging of a battery pack.

An exemplary embodiment provides a battery pack, including: a battery assembly having at least one battery cell; a protective circuit board electrically connected to the battery assembly; and an outer terminal electrically connecting the battery assembly to an external power supply or an external load. The protective circuit board may include: a charging and discharging device charging and discharging the battery assembly; a temperature device measuring the temperature of the battery assembly; and a charging and discharging controller electrically connected to the battery assembly, the charging and discharging device, and the temperature device and controlling the charging and discharging of the battery assembly. The temperature device may be set to measure the temperature of the battery assembly in the state in which the charging and discharging of the battery assembly stop.

The protective circuit board may further include a switching device that is electrically connected to the charging and discharging controller and controls the electrical connection of the battery assembly and the outer terminal.

The protective circuit board may further include a current measuring device that is electrically connected to the charging and discharging controller. In this case, the current measuring device may sense overcurrent or overvoltage flowing in the battery assembly during the charging or discharging of the battery assembly to transfer the stop signal of the charging and discharging of the battery assembly to the switching device through the charging and discharging controller.

The current measuring device may be set to measure current flowing in the battery assembly in the state in which the charging and discharging of the battery assembly stop.

The temperature device may be set to measure the temperature of the battery assembly when current flowing in the battery assembly is reduced to the referenced value or less in the state in which the charging and discharging of the battery assembly stops.

The protective circuit board may further include a timer that is electrically connected to the charging and discharging controller and measures the time when the charging and discharging of the battery assembly stop by the switching device.

The temperature device may be set to measure the temperature of the battery assembly when a predetermined time elapses after the charging and discharging of the battery assembly stops.

The current measuring device may be set to measure current flowing in the battery assembly when the predetermined time elapses after the charging and discharging of the battery assembly stop.

The temperature device may be set to measure the temperature of the battery assembly when the current flowing in the battery assembly is reduced to the reference value or less in the state in which the charging and discharging of the battery assembly stops.

Another exemplary embodiment provides a method for controlling charging and discharging of a battery pack, including: measuring current of a battery assembly; stopping the charging and discharging of the battery assembly by sensing overcurrent or overvoltage of the battery assembly; measuring the temperature of the battery assembly; and resuming the charging or discharging of the battery assembly when the temperature of the battery assembly is reduced to a reference value or less.

The method for controlling charging and discharging of a battery pack may further include measuring the current flowing in the battery assembly after the charging and discharging of the battery assembly stops, and the measuring the temperature of the battery assembly may be performed after the charging and discharging of the battery assembly stop and the current flowing in the battery assembly is reduced to the reference value or less.

After the charging and discharging of the battery assembly stop and the predetermined time elapses, the measuring the temperature of the battery assembly may be performed.

The method for controlling charging and discharging of a battery pack may further include measuring current flowing in the battery assembly after the predetermined time elapses, and the measuring the temperature of the battery assembly may be performed after the predetermined time elapses and the current flowing in the battery assembly is reduced to the reference value or less.

The stopping of the charging and discharging of the battery assembly and the resuming of the charging or discharging may use a switching device electrically connected to the battery assembly and the outer terminal.

According to the exemplary embodiments, the battery assembly can safely resume the charging or discharging of the battery pack after the charging and discharging of the battery pack stop due to the overvoltage or the overcurrent.

In particular, the present invention can promote safety in resuming the charging or discharging of the battery pack even when the battery cell of the battery pack is damaged due to the overvoltage or the overcurrent.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a flowchart showing an algorithm of a method for controlling charging and discharging of a battery pack according to a first exemplary embodiment;

FIG. 2 is a block diagram schematically showing the battery pack according to the first exemplary embodiment;

FIG. 3 is a flowchart showing an algorithm of a method for controlling charging and discharging of a battery pack according to a second exemplary embodiment;

FIG. 4 is a flowchart showing an algorithm of a method for controlling charging and discharging of a battery pack according to a third exemplary embodiment; and

FIG. 5 is a flowchart showing an algorithm of a method for controlling charging and discharging of a battery pack according to a fourth exemplary embodiment.

### DETAILED DESCRIPTION OF THE INVENTION

The present invention will be described more fully hereinafter with reference to the accompanying drawings, in which exemplary embodiments of the invention are shown. The drawings and description are to be regarded as illustrative in nature and not restrictive. Like reference numerals designate like elements throughout the specification.

In the specification and the claims that follow, when it is described that an element is “coupled” to another element, the element may be “directly coupled” to the other element or “electrically coupled” to the other element through a third element.

Recognizing that sizes and thicknesses of constituent members shown in the accompanying drawings are arbitrarily given for better understanding and ease of description, the present invention is not limited to the illustrated sizes and thicknesses.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. Alternatively, when an element is referred to as being “directly on” another element, there are no intervening elements present.

In order to clarify the present invention, elements extrinsic to the description are omitted from the details of this description, and like reference numerals refer to like elements throughout the specification.

In several exemplary embodiments, constituent elements having the same configuration are representatively described in a first exemplary embodiment by using the same reference numeral and only constituent elements other than the constituent elements described in the first exemplary embodiment will be described in other embodiments.

Rechargeable batteries may be used as a battery pack including a battery assembly having at least one battery cell according to the used purpose and usage and outer terminals capable of connecting it to an external power supply or external loads. Generally, the battery pack includes a protective apparatus that prevents overvoltage from being applied to a rechargeable battery or overcurrent from flowing thereto during the charging and discharging process. For example, when voltage or current with a predetermined value or more is sensed while the battery pack is charged and discharged, it may further include a protective circuit, or the like, that stops the charging and discharging.

As such, when the charging and discharging of the battery pack stop due to the overvoltage or the overcurrent, etc., by the protective circuit, etc., the charging or the discharging may be resumed by predetermined conditions. However, when the battery cell of the battery pack is damaged due to the overvoltage or overcurrent, the temperature of the cell is increased due to the internal chemical reaction, such that the battery pack may be in danger when it is reused.

Therefore, in reusing the battery pack by resuming the charging or discharging thereof, a need exists for a protective unit for safely reusing the battery pack in consideration of whether the battery cell is damaged or the damaged degree of the battery cell.

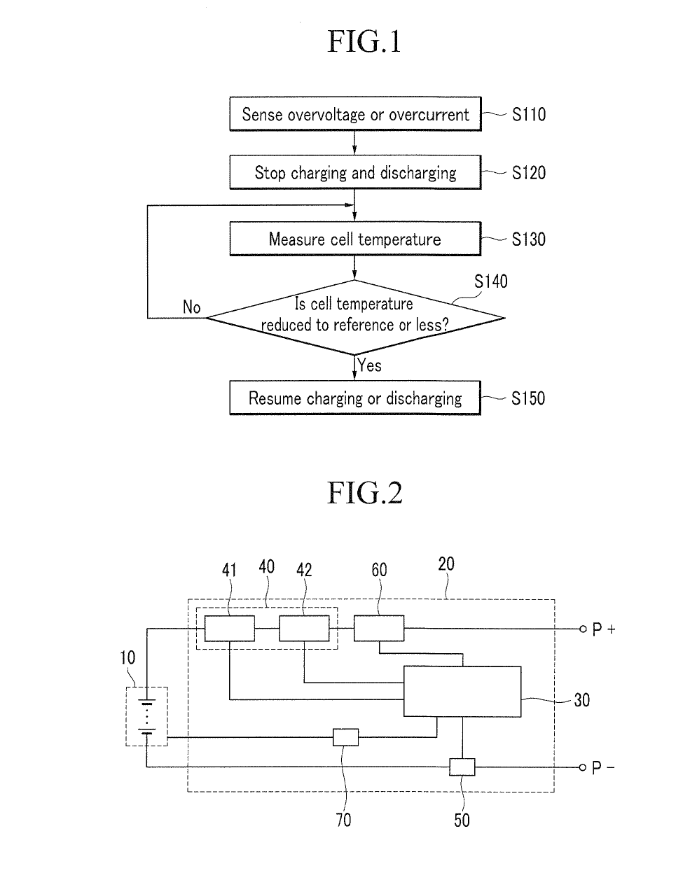

FIG. 1 is a flowchart showing an algorithm of a method for controlling charging and discharging of a battery pack according to a first exemplary embodiment and FIG. 2 is a block diagram schematically showing the battery pack according to the first exemplary embodiment. Hereinafter, a battery pack and a method for controlling charging and discharging thereof according to a first exemplary embodiment will be described with reference to FIGS. 1 and 2.

Referring first to FIG. 1, a method for controlling charging and discharging of a battery pack according to the first exemplary embodiment includes sensing overvoltage or overcurrent (S110), stopping charging and discharging (S120), measuring a temperature of a battery cell in a battery assembly 10 (S130), determining whether the temperature of the battery cell is reduced to a reference value or less (S140), and if so, resuming the charging or discharging (S150). That is, battery operation resumes when the reference value to the temperature is about equal to or less than 40° C.

That is, in the first exemplary embodiment, when the charging and discharging of the battery pack stops due to the overvoltage or overcurrent, the charging and discharging of the battery pack is resumed based on whether the temperature of the battery cell is sufficiently reduced to a reference value or less. Therefore, when the battery cell is damaged due to overvoltage or overcurrent, etc., the charging and discharging are resumed in consideration of the case in which the temperature of the battery cell may be increased due to internal chemical reaction, thereby making it possible to more safely reuse the battery pack.

The battery pack according to the first exemplary embodiment may include a battery assembly 10, a protective circuit board 20, and outer terminals P+ and P−. Referring to FIG. 2, a configuration of the battery pack and a method for controlling charging and discharging thereof will be described in detail.

The battery assembly 10 may be formed to include at least one battery cell capable of performing charging and discharging and electrically connected to a protective circuit board 20 and an outer terminal.

The outer terminal may include a positive terminal P+ and a negative terminal P− and serves to connect it to the external power supply or the external load during the charging and discharging of the battery assembly 10. Generally, when the outer terminal is connected to the external power supply, the charging of the battery assembly 10 is made and when the outer terminal is connected to the external load, the discharging of the battery assembly 10 is made.

The protective circuit board 20 may include a charging and discharging controller 30, a charging and discharging device 40, a current measuring device 50, a switching device 60, and a temperature device 70 and serves to stop the charging and discharging when overvoltage is applied to the battery assembly 10 or overcurrent flows therein and to resume it.

The charging and discharging device 40 of the protective circuit board 20 may be connected to the battery assembly 10 and includes a charging field effect transistor (FET) 41 and a discharging FET 42 and when the charging FET 41 is driven, the charging is performed and when the discharging FET 42 is driven, the discharging is performed. The charging and discharging device 40 may be connected to the charging and discharging controller 30 and any one of the charging FET 41 or the discharging FET 42 is driven to perform the charging or discharging of the battery assembly 10 by the control of the charging and discharging controller 30.

The current measuring device 50 of the protective circuit board 20 may include a sensor resistor and is connected to the battery assembly 10 to sense current flowing in the battery assembly 10. When overcurrent of a predetermined reference value or more flowing in the battery assembly 10 through the current measuring device 50 is sensed, the current measuring device 50 transfers the stop signals to the charging and discharging controller 30 so that the charging and discharging of the battery assembly 10 stop and transfers the stop signals to a switching device 60 through the charging and discharging controller 30. Meanwhile, instead of the current measuring device 50, the voltage measuring device capable of measuring the voltage of the battery assembly 10 may be formed and the current measuring device 50 may be further formed with the voltage measuring device.

The switching device 60 of the protective circuit board 20 is a device that can control the turn-on and off of the electrical connection between the battery assembly 10 and the outer terminal. As described above, when the stop signal of the charging and discharging are transferred through the charging and discharging controller 30, the switching device 60 is turned-off and thus, the connection between the battery assembly 10 and the outer power supply or the outer load is blocked to stop the charging and discharging of the battery assembly 10.

The temperature device 70 of the protective circuit board 20 may be connected to the battery assembly 10 to serve to stop the charging and discharging of the battery assembly 10 and then measure the temperature of the batter cell in the battery assembly 10. As described above, when the battery cell is damaged due to overvoltage or overcurrent, the temperature of the battery cell may be increased by the internal chemical reaction and when the charging or discharging is made in the state in which the temperature of the battery cell is increased, since danger such as the deterioration or explosion, etc., of the battery pack may occur, the charging or discharging is resumed only when the temperature of the battery cell reduces to the reference value or less. That is, the temperature sensor 70 continuously senses and measures the temperature of the battery cell to transfer the resume signal of the charging or discharging to the charging and discharging controller 30 when the temperature of the battery cell is reduced to the predetermined reference value or less in consideration of safety. As described above, the resume signal of the charging and discharging is transferred to the switching device 60 through the charging and discharging controller 30 and thus, the charging or discharging is resumed by the connection of the battery assembly 10 to the outer power supply or the outer load.

As such, the battery pack according to the first exemplary embodiment may include the protective circuit board 20 having the temperature sensor 70 to resume the charging and discharging only when the temperature of the battery cell in the battery assembly 10 is reduced to the reference value or less, thereby making it possible to secure the safety and reliability in reusing the battery pack.

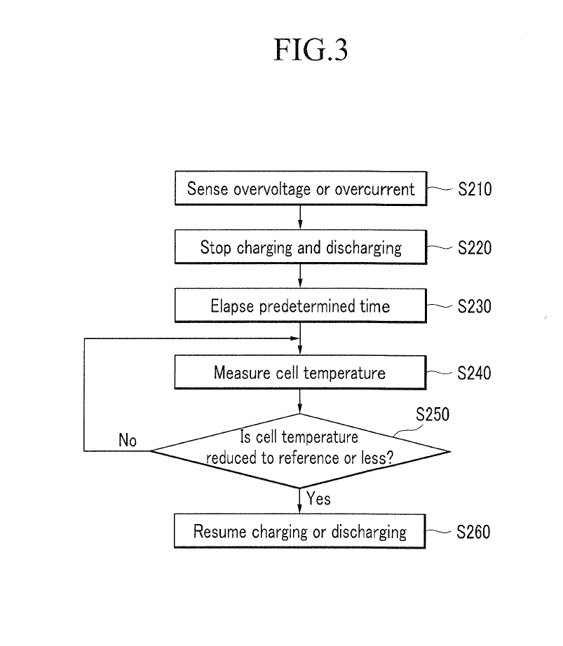

Another exemplary embodiment will be described with reference to FIGS. 3 to 5. In this case, in each exemplary embodiment, the description of the same components as the first exemplary embodiment will be brief or omitted.

FIG. 3 is a flowchart showing an algorithm of a method for controlling charging and discharging of a battery pack according to a second exemplary embodiment.

Referring to FIG. 3, a method for controlling charging and discharging of the battery pack according to the second exemplary embodiment may include sensing overvoltage or overcurrent (S210), stopping charging and discharging (S220), measuring a temperature of a battery cell in a battery assembly (S240) after the predetermined time elapses (S230), determining whether the temperature of the battery cell is reduced to a reference value or less (S250), and if so, resuming the charging or discharging (S260). That is, battery operation resumes when the reference value to the temperature is about equal to or less than 40° C.

Comparing the second exemplary embodiment with the first exemplary embodiment, the second exemplary embodiment is different from the first exemplary embodiment in that the temperature of the battery cell is measured after the charging and discharging of the battery assembly stop and the predetermined time elapses. In this case, the predetermined time is the predetermined time consumed to reduce voltage or current to the predetermined level after the charging and discharging stop when the overvoltage or the overcurrent is sensed. That is, according to the second exemplary embodiment, after voltage or current is reduced to a predetermined level or less, the temperature of the battery cell is measured.

The configuration of the battery pack according to the second exemplary embodiment further may form a timer in the protective circuit board in the configuration of the battery pack according to the first exemplary embodiment, thereby confirming whether the predetermined time elapses. In detail, the additionally formed timer may be connected to the charging and discharging controller of the protective circuit board and transfers the measuring signals to the charging and discharging controller to measure the temperature of the battery cell of the battery assembly by using the temperature device after the predetermined time elapses from the instant where the switching device is turned-off.

Therefore, after voltage or current is reduced to a predetermined level or less, the charging or discharging is resumed, thereby making it possible to more safely reuse the battery pack. In addition, since the temperature of the battery cell is measured using the temperature device after the charging and discharging stop and the predetermined time elapses, there is no need to operate the temperature device immediately after the charging and discharging stop, thereby making it possible to more efficiently perform the process of resuming the charging or discharging of the battery pack.

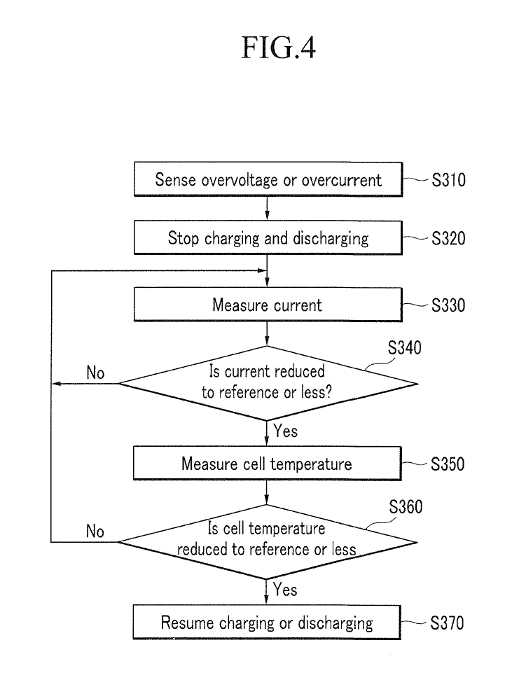

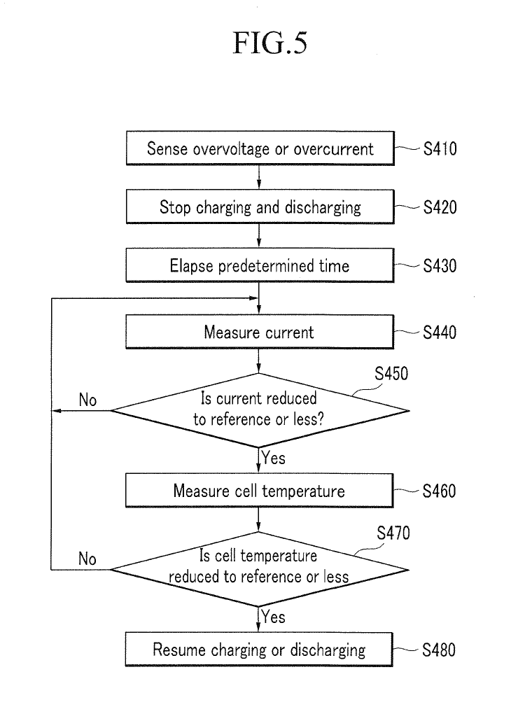

FIG. 4 is a flowchart showing an algorithm of a method for controlling charging and discharging of a battery pack according to a third exemplary embodiment.

Referring to FIG. 4, a method for controlling charging and discharging of the battery pack according to the third exemplary embodiment includes sensing overvoltage or overcurrent (S310), stopping charging and discharging (S320), measuring current of the battery assembly (S330), determining whether current is reduced to the reference value or less (S340), if so, measuring the temperature of the battery cell of the battery assembly (S350), determining whether the temperature of the battery cell is reduced to the reference value or less (S360), and if so, resuming the charging or discharging (S370).

However, the range of the voltage or current under which battery operation stops or resumes may vary. For instance, when the voltage of the battery is equal to or exceeds 4.25V, it will be considered an overcharge. If the voltage is equal to or less than 4.15V, the battery operation will resume. Further, the battery operation may stop when the charge or discharge current is 1 C-rate. Meanwhile, battery operation resumes when current in the opposite direction is sensed.

Therefore, battery operation may resume when the voltage is equal to or less than 4.15V and the temperature is equal to or less than 40° C. Further, battery operation may resume when the current in the opposite direction is sensed and the temperature is equal to or less than 40° C.

Comparing the third exemplary embodiment with the first exemplary embodiment, the third exemplary embodiment is different from the first exemplary embodiment in that the temperature of the battery cell is measured after the charging and discharging of the battery assembly stop and the current is reduced to the reference value or less. That is, according to the third exemplary embodiment, even though the current flowing in the battery assembly resumes the charging or discharging, the temperature of the battery cell is measured after it is reduced to the safe level or less.

The battery pack according to the third exemplary embodiment is similarly formed to the configuration of the battery pack according to the first exemplary embodiment. However, the current measuring device connected to the battery assembly senses overcurrent to transfer the charging and discharging stop signals to the charging and discharging controller. Thereafter, the current measuring device continuously senses and measures the current of the battery assembly. The current measuring device transfers the measuring signals to the charging and discharging controller to measure the temperature of the battery cell of the battery assembly by using the temperature device when the current flowing in the battery assembly is reduced to the predetermined level or less.

Therefore, after voltage or current is reduced to a predetermined level or less, the charging or discharging is resumed, thereby making it possible to more safely reuse the battery pack. In addition, since the temperature of the battery cell is measured using the temperature device after the charging and discharging stop and the predetermined time elapses, there is no need to operate the temperature device immediately after the charging and discharging stop, thereby making it possible to more efficiently perform the process of resuming the charging or discharging of the battery pack.

FIG. 5 is a flowchart showing an algorithm of a method for controlling charging and discharging of a battery pack according to a fourth exemplary embodiment.

Referring to FIG. 5, a method for controlling charging and discharging of the battery pack according to the fourth exemplary embodiment includes sensing overvoltage or overcurrent (S410), stopping charging and discharging (S420), measuring current of the battery assembly (S440) after the predetermined time elapses (S430), determining whether current is reduced to the reference value or less (S450), if so, measuring the temperature of the battery cell of the battery assembly (S460), determining whether the temperature of the battery cell is reduced to the reference value or less (S470), and if so, resuming the charging or discharging (S480).

However, the range of the voltage or current under which battery operation stops or resumes may vary. For instance, when the voltage of the battery is equal to or exceeds 4.25V, it will be considered an overcharge. If the voltage is equal to or less than 4.15V, the battery operation will resume. Further, the battery operation may stop when the charge or discharge current is 1 C-rate. Meanwhile, battery operation resumes when current in the opposite direction is sensed.

Therefore, battery operation may resume when the voltage is equal to or less than 4.15V and the temperature is equal to or less than 40° C. Further, battery operation may resume when the current in the opposite direction is sensed and the temperature is equal to or less than 40° C.

Comparing the fourth exemplary embodiment with the first exemplary embodiment, the fourth exemplary embodiment is different from the first exemplary embodiment in that the temperature of the battery cell is measured after the charging and discharging of the battery assembly stop, the predetermined time elapses, and current is reduced to the reference value or less. In this case, the predetermined time is the predetermined time consumed to reduce voltage or current to the predetermined level after the charging and discharging stop when the overvoltage or the overcurrent is sensed.

The battery pack according to the fourth exemplary embodiment is similarly formed to the configuration of the battery pack according to the second exemplary embodiment.

That is, the configuration of the battery pack according to the fourth exemplary embodiment further forms a timer in the protective circuit board in the configuration of the battery pack according to the first exemplary embodiment, thereby confirming whether the predetermined time elapses.

Further, the current measuring device connected to the battery assembly senses overcurrent to transfer the charging and discharging stop signals to the charging and discharging controller. Thereafter, the current measuring device continuously senses and measures the current of the battery assembly, thereby confirming whether the current flowing in the battery assembly is reduced to the predetermined level or less. Therefore, when the predetermined time elapses and the current flowing in the battery assembly is reduced to the predetermined level or less after the charging and discharging stop, the measuring signals are transferred to the charging and discharging controller to measure the temperature of the battery cell of the battery assembly by using the temperature device.

Therefore, after voltage or current is reduced to a predetermined level or less, the charging or discharging is resumed, thereby making it possible to more safely reuse the battery pack. In addition, since the current flowing in the battery assembly and the temperature of the battery cell is measured using the current measuring device and the temperature device, respectively, after the charging and discharging stop and the predetermined time elapses, there is no need to operate the current measuring device and the temperature device immediately after the charging and discharging stop, thereby making it possible to more efficiently perform the process of resuming the charging or discharging of the battery pack.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A battery pack, comprising:
a battery assembly having at least one battery cell;
a protective circuit board electrically connected to the battery assembly; and
an outer terminal electrically connecting the battery assembly to an external power supply or an external load,
wherein the protective circuit board includes:
a charging and discharging device charging and discharging the battery assembly;
a temperature device measuring the temperature of the battery assembly; and
a charging and discharging controller electrically connected to the battery assembly, the charging and discharging device, and the temperature device and controlling the charging and discharging of the battery assembly; and
the temperature device is set to measure the temperature of the battery assembly in the state in which the charging and discharging of the battery assembly stop.

2. The battery pack of claim 1, wherein:
the protective circuit board further includes a switching device that is electrically connected to the charging and discharging controller and controls the electrical connection of the battery assembly and the outer terminal.

3. The battery pack of claim 1, wherein:
the protective circuit board further includes a current measuring device that is electrically connected to the charging and discharging controller, and
the current measuring device senses overcurrent or overvoltage flowing in the battery assembly during the charging or discharging of the battery assembly to transfer the stop signal of the charging and discharging of the battery assembly to the switching device through the charging and discharging controller.

4. The battery pack of claim 3, wherein:
the current measuring device is set to measure current flowing in the battery assembly in the state in which the charging and discharging of the battery assembly stops.

5. The battery pack of claim 4, wherein:
the temperature device is set to measure the temperature of the battery assembly when current flowing in the battery assembly is reduced to the referenced value or less in the state in which the charging and discharging of the battery assembly stops.

6. The battery pack of claim 3, wherein:
the protective circuit board further includes a timer that is electrically connected to the charging and discharging controller and measures the time when the charging and discharging of the battery assembly stop by the switching device.

7. The battery pack of claim 6, wherein:
the temperature device is set to measure the temperature of the battery assembly when a predetermined time elapses after the charging and discharging of the battery assembly stops.

8. The battery pack of claim 6, wherein:
the current measuring device is set to measure current flowing in the battery assembly when the predetermined time elapses after the charging and discharging of the battery assembly stop.

9. The battery pack of claim 8, wherein:
the temperature device is set to measure the temperature of the battery assembly when the current flowing in the battery assembly is reduced to the reference value or less in the state in which the charging and discharging of the battery assembly stops.

10. A method for controlling charging and discharging of a battery pack, comprising:
measuring current of a battery assembly;
stopping the charging and discharging of the battery assembly by sensing overcurrent or overvoltage of the battery assembly;
measuring the temperature of the battery assembly; and
resuming the charging or discharging of the battery assembly when the temperature of the battery assembly is reduced to a reference value or less.

11. The method of claim 10, further comprising:
measuring the current flowing in the battery assembly after the charging and discharging of the battery assembly stops,
the measuring the temperature of the battery assembly is performed after the charging and discharging of the battery assembly stop and the current flowing in the battery assembly is reduced to the reference value or less.

12. The method of claim 10, wherein:
the measuring the temperature of the battery assembly is performed after the charging and discharging of the battery assembly stop and the predetermined time elapses.

13. The method of claim 12, further comprising:
measuring current flowing in the battery assembly after the predetermined time elapses, and
the measuring the temperature of the battery assembly is performed after the predetermined time elapses and the current flowing in the battery assembly is reduced to the reference value or less.

14. The method of claim 10, wherein:
the stopping of the charging and discharging of the battery assembly and the resuming of the charging or discharging uses a switching device electrically connected to the battery assembly and the outer terminal.

15. A method for controlling charging and discharging of a battery pack, comprising:
measuring current of a battery assembly;
stopping the charging and discharging of the battery assembly upon sensing overcurrent or overvoltage of the battery assembly;
measuring the temperature of the battery assembly; and
resuming the charging or discharging of the battery assembly when the current of the battery assembly is reduced to a first reference value and the temperature of the battery assembly is reduced to a second reference value,
wherein the first reference value is greater than or equal to zero volts under all circumstances and the second reference value is greater than zero degrees Kelvin under all circumstances.

16. The method of claim 15, further comprising:
measuring the current flowing in the battery assembly after the charging and discharging of the battery assembly stops,
the measuring the temperature of the battery assembly is performed after the charging and discharging of the battery assembly stop and the current flowing in the battery assembly is reduced to the reference value or less.

17. The method of claim 15, wherein:
the measuring the temperature of the battery assembly is performed after the charging and discharging of the battery assembly stop and the predetermined time elapses.

18. The method of claim 17, further comprising:
measuring current flowing in the battery assembly after the predetermined time elapses, and
the measuring the temperature of the battery assembly is performed after the predetermined time elapses and the current flowing in the battery assembly is reduced to the reference value or less.

19. The method of claim 15, wherein:
the stopping of the charging and discharging of the battery assembly and the resuming of the charging or discharging uses a switching device electrically connected to the battery assembly and the outer terminal.

20. The battery pack of claim 1, wherein charging and discharging of the battery assembly resumes when the temperature is about equal to or less than 40° C.

21. The battery pack of claim 9, wherein charging and discharging of the battery assembly resumes when the reference value is about equal to or less than 4.15V and the temperature is about equal to or less than 40° C.
